(19) United States
(12) Patent Application Publication
(10) Pub. No.: US 2023/0018325 A1
(43) Pub. Date: Jan. 19, 2023

(54) LIGHTING APPARATUS INCLUDING A SOUND DAMPENING BAFFLE ASSEMBLY AND A SOUND DAMPENING BAFFLE ASSEMBLY FOR A LIGHTING APPARATUS

(71) Applicant: Delray Lighting, LLC, Burbank, CA (US)

(72) Inventors: David George Komonosky, Los Angeles, CA (US); Aaromi Jordan Willette, Palm Springs, CA (US); Alexis Schlemer, Culver City, CA (US); Stephen Lee Babbitt, Glendale, CA (US)

(21) Appl. No.: 17/862,640

(22) Filed: Jul. 12, 2022

Related U.S. Application Data
(60) Provisional application No. 63/221,048, filed on Jul. 13, 2021.

(51) Int. Cl. F21V 33/00; F21V 21/02; G10K 11/16

(52) U.S. Cl. CPC F21V 33/006; F21V 21/02; G10K 11/16

(57) ABSTRACT

A combination is provided including lighting apparatus and a baffle assembly. The lighting apparatus comprises a frame and a light source. The baffle assembly comprises a plurality of sound dampening baffles that can be attached to the frame and help dampen sound near the lighting apparatus.

### RELATED APPLICATION

This application is a continuation of U.S. Provisional Application No. 63/221,048, filed Jul. 13, 2021, the entire contents of which are hereby incorporated by reference.

### FIELD

The present invention generally relates to a combination including a lighting apparatus and sound dampening baffle assembly. The present invention also relates to a sound dampening baffle assembly for a lighting apparatus.

### BACKGROUND

Attempts have been made to add sound dampening materials to lighting apparatuses. For example, some have added sound dampening materials to lighting apparatuses by mechanically or adhesively fixing those materials to the apparatuses. However, such attempts have been cumbersome since the use of mechanical tools and adhesives add complexity. Additionally, previous sound dampening materials added to lighting apparatuses often do not dampen enough sound as desired. It would be desirable to provide a sound dampening system that is easy to add to a lighting apparatus. It would also be desirable to provide for a sound dampening system for a lighting apparatus that dampens more sound.

### SUMMARY OF THE INVENTION

Various embodiments of the present invention provide a combination including lighting apparatus and a baffle assembly. The lighting apparatus comprises a frame and a light source. In some cases, the lighting apparatus can be a suspended lighting apparatus and the frame can be suspended to extend in a substantially horizontal plane.

The frame can include an outer sidewall, an inner sidewall, a top sidewall, and a bottom sidewall. The outer sidewall can define an outer perimeter. The inner sidewall can define a substantially hollow interior. The top sidewall can face a ceiling and the bottom sidewall can be opposite the top sidewall. In some cases, the bottom sidewall can include the light source.

The baffle assembly can include a plurality of sound dampening baffles housed within the substantially hollow interior and fixed to the frame. In some cases, the baffle assembly can consist essentially of a plurality of sound dampening baffles. Further, in some cases, the plurality of sound dampening baffles can consist essentially of a single material. In certain cases, the single material can include a rigid material, such as a polyethylene terephthalate.

Further, in some cases, the baffle assembly can protrude downward from the bottom sidewall of the frame for a distance. For example, the distance can be a distance that is greater than the frame height, such as a distance that is more than two times (or more than three times or more than four times or more than five times or more than six times or more than seven times or more than eight times or more than nine times or more than ten times) the frame height.

Likewise, in some cases, the baffle assembly can protrude upward from the top sidewall of the frame for a distance. For example, the distance can be a distance that is greater than the frame height, such as a distance that is more than two times (or more than three times or more than four times or more than five times or more than six times or more than seven times or more than eight times or more than nine times or more than ten times) the frame height.

In some cases, the baffle assembly protrudes outward past the outer perimeter of the frame. However, in other cases, the baffle assembly does not protrude outward past the outer perimeter.

The frame can have a frame height and the baffle assembly can have a baffle assembly height. In some cases, the baffle assembly height is more than two times (or more than three times or more than four times or more than five times or more than six times or more than seven times or more than eight times or more than nine times or more than ten times) the frame height.

In some cases, the substantially hollow interior defined by the inner sidewall has an area, and the baffle assembly has a total exposed surface of the plurality of sound dampening baffles, wherein the total exposed surface has a surface area that is greater than the area of the substantially hollow interior. For example, the total exposed surface can have a surface area that is more than two times (or more than three times or more than four times or more than five times or more than six times or more than seven times or more than eight times or more than nine times or more than ten times) the area of the substantially hollow interior.

Further, in some cases, each baffle in the plurality of sound dampening baffles extends in a substantially vertical plane such that the plurality of sound dampening baffles defines a plurality of flow-through spaces, wherein some air or water can move vertically through the flow-through spaces without contacting any structure extending in a horizontal plane.

The frame can be selected from the group consisting of a circular frame, an elliptical frame, a square frame, a rectangular frame, a triangular frame, and a trapezoid frame. In certain cases, the frame is a circular frame. The circular frame can also have an outer diameter selected from the group consisting of 2 feet, 3 feet, 4 feet, 5 feet, 6 feet, 7 feet, 8 feet, 9 feet and 10 feet.

In some cases, the baffle assembly is attached to the frame without being adhesively or mechanically fixed to the frame. For example, in certain cases, the baffle assembly consists essentially of a plurality of sound dampening baffles that are attached to the frame without being adhesively or mechanically fixed to the frame or any other component.

The frame can have a frame weight and the baffle assembly can have a baffle assembly weight. In some cases, the baffle assembly weight is less than the frame weight. In certain cases, the baffle assembly weight is less than 90% (or less than 80%, less the frame weight, less than 80% the frame weight, less than 70% the frame weight, less than 60% the frame weight or less than 50% the frame weight.

Other embodiments provide a lighting apparatus and baffle assembly combination. The lighting apparatus comprises a frame and a light source and the frame extends in a substantially horizontal plane. The baffle assembly comprises a plurality of sound dampening baffles, wherein the plurality of sound dampening baffles includes a plurality of primary baffles extending in a substantially vertical plane, and a plurality of secondary baffles extending in a substantially vertical plane, wherein the primary baffles are perpendicular to the secondary baffles.

In some cases, at least one primary baffle of the plurality of primary baffles is attached to each secondary baffle of the plurality of secondary baffles and at least one secondary baffle of the plurality of secondary baffles is attached to each primary baffle of the plurality of primary baffles. In certain cases, each primary baffle of the plurality of primary baffles is attached to each secondary baffle of the plurality of secondary baffles and each secondary baffle of the plurality of secondary baffles is attached to each primary baffle of the plurality of primary baffles.

Also, at least one primary baffle can be slidably engaged with each secondary baffle of the plurality of secondary baffles and at least one secondary baffle can be slidably engaged with each primary baffle of the plurality of primary baffles. In certain cases, each primary baffle is slidably engaged with each secondary baffle of the plurality of secondary baffles and wherein each secondary baffle is slidably engaged with each primary baffle of the plurality of primary baffles.

In some cases, each primary baffle of the plurality of primary baffles includes a top edge, a bottom edge and a plurality of bottom slots extending upward from the bottom edge, and each secondary baffle of the plurality of secondary baffles includes a top edge, a bottom edge, and a plurality of top slots extending downward from the top edge. In specific cases, at least one bottom slot of the plurality of bottom slots is slidably engaged with at least one top slot of the plurality of top slots. For example, at least one bottom slot can have a closed bottom slot end and at least one top slot can have a closed top slot end, wherein the closed bottom slot end abuts the closed top slot end.

In further cases, each primary baffle of the plurality of primary baffles includes a side edge and a plurality of side slots extending inward from the side edge, and each secondary baffle of the plurality of secondary baffles includes a side edge and a plurality of side slots extending inward from the side edge.

Also, the plurality of primary baffles can include a central primary baffle and the plurality of secondary baffles can include a central secondary baffle, wherein the central primary baffle intersects with the central secondary baffle at a central midpoint. In certain cases, the plurality of primary baffles includes additional primary baffles positioned further from a central midpoint than the central primary baffle, and the plurality of secondary baffles includes additional secondary baffles positioned further from a central midpoint than the central secondary baffle. Also, in certain cases, the central primary baffle has a width that is greater than a width of the additional primary baffles, and the central secondary baffle has a width that is greater than a width of the additional secondary baffles.

Other embodiments of the invention provide a baffle assembly. The baffle assembly can include a plurality of primary baffles extending in a substantially vertical plane, and a plurality of secondary baffles extending in a substantially vertical plane, wherein the plurality of primary baffles are perpendicular to the plurality of secondary baffles, and wherein at least one primary baffle of plurality of primary baffles is attached to each secondary baffle of the plurality of secondary baffles and at least one secondary baffle of the plurality of secondary baffles is attached to each primary baffle of the plurality of primary baffles.

Also, in certain cases, at least one primary baffle comprises a top edge and a bottom edge, wherein the bottom edge defines a substantially straight abutment edge configured to abut a top sidewall of a structure. The at least one primary baffle can also comprise an abutment corner configured to abut a top sidewall and a vertical sidewall of a structure.

Likewise, at least one secondary baffle comprises an abutment corner configured to abut a top sidewall and a vertical sidewall of a structure. Further, the at least one secondary baffle can include an abutment corner configured to abut a top sidewall and a vertical sidewall of a structure.

Also, at least one primary baffle can be slidably engaged with each secondary baffle of the plurality of secondary baffles and at least one secondary baffle can be slidably engaged with each primary baffle of the plurality of primary baffles.

In some cases, each primary baffle of the plurality of primary baffles includes a top edge, a bottom edge and a plurality of bottom slots extending upward from the bottom edge, and each secondary baffle of the plurality of secondary baffles includes a top edge, a bottom edge, and a plurality of top slots extending downward from the top edge. In certain cases, at least one bottom slot of the plurality of bottom slots is slidably engaged with at least one top slot of the plurality of top slots. Also, in certain cases, the at least one bottom slot has a closed bottom slot end and the at least one top slot has a closed top slot end, wherein the closed bottom slot end abuts the closed top slot end.

The plurality of primary baffles can also include a central primary baffle and the plurality of secondary baffles can include a central secondary baffle, wherein the central primary baffle intersects with the central secondary baffle at a central midpoint. Further, the plurality of primary baffles can also include additional primary baffles positioned further from a central midpoint than the central primary baffle, and the plurality of secondary baffles further can also include additional secondary baffles positioned further from a central midpoint than the central secondary baffle. In some cases, the central primary baffle has a width that is greater than a width of the additional primary baffles, and the central secondary baffle has a width that is greater than a width of the additional secondary baffles.

In certain cases, the baffle assembly consists essentially of a single material, for example polyethylene terephthalate.

Further, in some cases, the primary baffles intersect the secondary baffles to define a plurality of flow-through spaces, wherein some air or water can move vertically through the flow-through spaces without contacting any structure extending in a horizontal plane.

### BRIEF DESCRIPTION OF THE DRAWINGS

The following drawings are illustrative of particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIG. 1 is a perspective view of a lighting apparatus and baffle assembly combination according to certain embodiments.

FIG. 2 is a perspective view of a lighting apparatus configured to receive a baffle assembly according to certain embodiments.

FIG. 3 is a side view of a frame of the lighting apparatus.

FIG. 4 is a top view of the frame of the lighting apparatus.

FIG. 5 is a bottom perspective view of the frame of the lighting apparatus.

FIG. 6 is a top perspective view of the frame of the lighting apparatus.

FIG. 7 is a bottom perspective view of a baffle assembly and frame combination according to a first embodiment.

FIG. 8 is a top perspective view of the baffle assembly and frame combination of the first embodiment.

FIG. 9 is a side view of the baffle assembly and frame combination of the first embodiment.

FIG. 10 is a top view of the baffle assembly and frame combination of the first embodiment.

FIG. 11 is a top perspective view of the baffle assembly of the first embodiment.

FIG. 12 is a bottom perspective view of the baffle assembly of the first embodiment.

FIG. 13 is an exploded perspective view of primary panels of the baffle assembly of the first embodiment.

FIG. 14 is an exploded perspective view of secondary panels of the baffle assembly of the first embodiment.

FIG. 15 is a side view of an outer primary panel of the baffle assembly of the first embodiment.

FIG. 16 is a side view of an inner primary panel of the baffle assembly of the first embodiment.

FIG. 17 is a side view of a central primary panel of the baffle assembly of the first embodiment.

FIG. 18 is a side view of an outer secondary panel of the baffle assembly of the first embodiment.

FIG. 19 is a side view of an inner secondary panel of the baffle assembly of the first embodiment.

FIG. 20 is a side view of a central secondary panel of the baffle assembly of the first embodiment.

FIG. 21 is a bottom perspective view of a baffle assembly and frame combination according to a second embodiment.

FIG. 22 is a top perspective view of the baffle assembly and frame combination of the second embodiment.

FIG. 23 is a side view of the baffle assembly and frame combination of the second embodiment.

FIG. 24 is a top view of the baffle assembly and frame combination of the second embodiment.

FIG. 25 is a top perspective view of the baffle assembly of the second embodiment.

FIG. 26 is a bottom perspective view of the baffle assembly of the second embodiment.

FIG. 27 is an exploded perspective view of primary panels of the baffle assembly of the second embodiment.

FIG. 28 is an exploded perspective view of secondary panels of the baffle assembly of the second embodiment.

FIG. 29 is a side view of an outer primary panel of the baffle assembly of the second embodiment.

FIG. 30 is a side view of an inner primary panel of the baffle assembly of the second embodiment.

FIG. 31 is a side view of a central primary panel of the baffle assembly of the second embodiment.

FIG. 32 is a side view of an outer secondary panel of the baffle assembly of the second embodiment.

FIG. 33 is a side view of an inner secondary panel of the baffle assembly of the second embodiment.

FIG. 34 is a side view of a central secondary panel of the baffle assembly of the second embodiment.

FIG. 35 is a bottom perspective view of a baffle assembly and frame combination according to a third embodiment.

FIG. 36 is a top perspective view of the baffle assembly and frame combination of the third embodiment.

FIG. 37 is a side view of the baffle assembly and frame combination of the third embodiment.

FIG. 38 is a top view of the baffle assembly and frame combination of the third embodiment.

FIG. 39 is a top perspective view of the baffle assembly of the third embodiment.

FIG. 40 is a bottom perspective view of the baffle assembly of the third embodiment.

FIG. 41 is a bottom perspective view of a baffle assembly and frame combination according to a fourth embodiment.

FIG. 42 is a top perspective view of the baffle assembly and frame combination of the fourth embodiment.

FIG. 43 is a side view of the baffle assembly and frame combination of the fourth embodiment.

FIG. 44 is a top view of the baffle assembly and frame combination of the fourth embodiment.

FIG. 45 is a top perspective view of the baffle assembly of the fourth embodiment.

FIG. 46 is a bottom perspective view of the baffle assembly of the fourth embodiment.

FIG. 47 is a bottom perspective view of a baffle assembly and frame combination according to a fifth embodiment.

FIG. 48 is a top perspective view of the baffle assembly and frame combination of the fifth embodiment.

FIG. 49 is a side view of the baffle assembly and frame combination of the fifth embodiment.

FIG. 50 is a top view of the baffle assembly and frame combination of the fifth embodiment.

FIG. 51 is a top perspective view of the baffle assembly of the fifth embodiment.

FIG. 53 is a bottom perspective view of the baffle assembly of the fifth embodiment.

FIG. 54 is a side view of a primary panel of the baffle assembly of the fifth embodiment.

### DETAILED DESCRIPTION OF THE INVENTION

For the purpose of promoting an understanding of the principles of the invention, reference will now be made to the embodiments illustrated in the drawing and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which the invention relates.

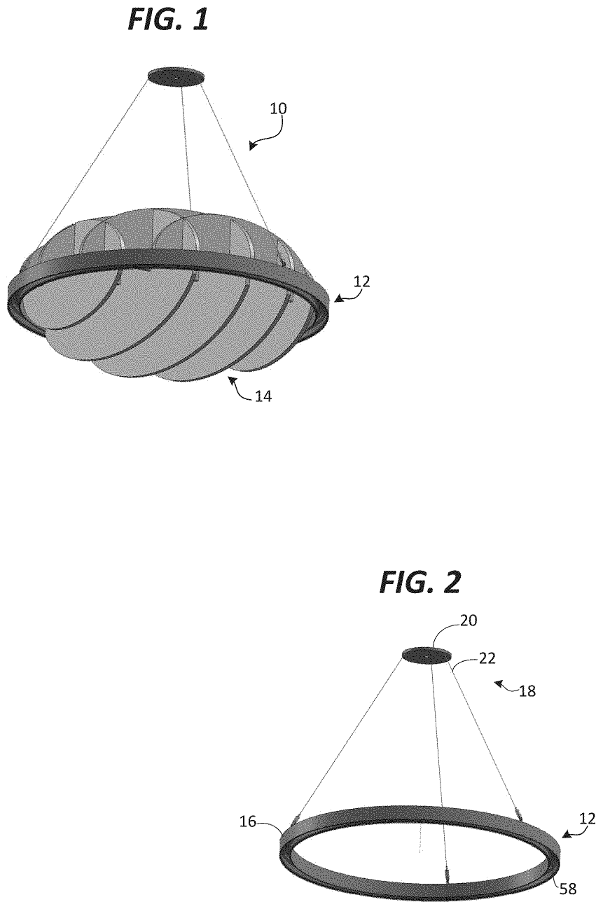

FIG. 1 illustrates a general lighting apparatus and baffle assembly combination 10 according to one exemplary embodiment. The combination 10 includes a lighting apparatus 12, a baffle assembly and a frame 16.

As shown in FIG. 2, the lighting apparatus 12 includes a frame 16 and a light source 58 provided on a surface of the frame 16. The frame 16 can be a suspended frame that is suspended by a suspension system 18. In certain embodiments, the suspension system 18 includes a mounting structure 20 and a plurality of cables 22. The mounting structure 20 mounts to a ceiling. A plurality of cables 22 or other supports are fixed to both the frame 16 and mounting structure 20 such that the frame 16 is suspended to extend in substantially horizontal plane X. In the illustrated embodiment, the plurality of cables 30 includes three cables, although other cable numbers can be instead used depending on the shape and size of the frame 16. Skilled artisans will also understand that other embodiments of suspension systems can also be used.

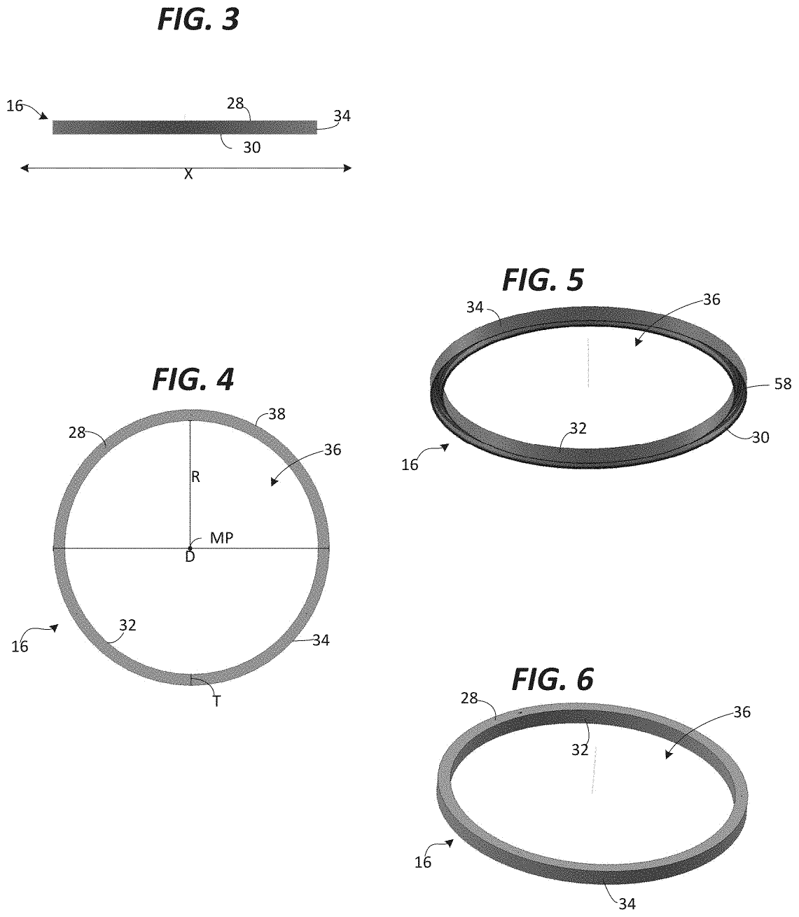

FIGS. 3-6 illustrate a frame 16 of the lighting apparatus 12 of the combination 10. The frame 16 extends in a substantially horizontal plane X and includes a top sidewall 28, a bottom sidewall 30, an inner sidewall 32 and an outer sidewall 34. The top sidewall 28 generally faces a ceiling and the bottom sidewall 30 is opposite the top sidewall 28. Also, the inner sidewall 32 defines a substantially hollow interior 36 and the outer sidewall 34 defines an outer perimeter 38. Further, the light source 58 can be provided on any of the sidewall of the frame 16 but in preferred embodiments is provided on the bottom sidewall 30.

In the illustrated embodiment, the frame 16 is shown as a circular frame. Referring to FIG. 5, the circular frame includes a diameter D that is an outer diameter taken from the outer sidewall 42. The circular frame can have a diameter D of between 1 foot and 11 foot, such as between 2 feet and 6 feet. In certain cases, the diameter D is selected from 2 feet, 3 feet, 4 feet, 5 feet, 6 feet, 7 feet, 8 feet, 9 feet and 10 feet. Skilled artisans will understand that these diameters listed are nominal and can generally vary plus or minus one or two inches. The circular frame can also have a radius R that extends from a center midpoint MP of the circle to an inner sidewall 32. Thus, the substantially hollow interior 36 is provided with a cross-sectional area A. Finally, the frame 16 has a thickness T that is a distance from the inner sidewall 32 to the outer sidewall 34. In some cases, the thickness T is at least 1 inch or perhaps at least 2 inches.

While a circular frame is illustrated, skilled artisans will understand that other shapes and sizes can instead be used for the frame 16. For example, the frame can also be provided as an elliptical frame, a square frame, a rectangular frame, a triangular frame and a trapezoid frame. Likewise, the frame can be provided to have an irregular or blob-like shape. When provided as another other desired shape, the frame will still include a substantially horizontal plane X and includes a top sidewall, a bottom sidewall, an inner sidewall and an outer sidewall. The sidewalls of the frame will simply be configured to form the desired frame shape. Here too, the top sidewall generally faces a ceiling and the bottom sidewall is opposite the top sidewall. Also, the inner sidewall of a frame defines a substantially hollow interior and the outer sidewall defines an outer perimeter. Further, the light source can also be provided on any of the sidewall of the frame but in preferred embodiments is provided on the bottom sidewall.

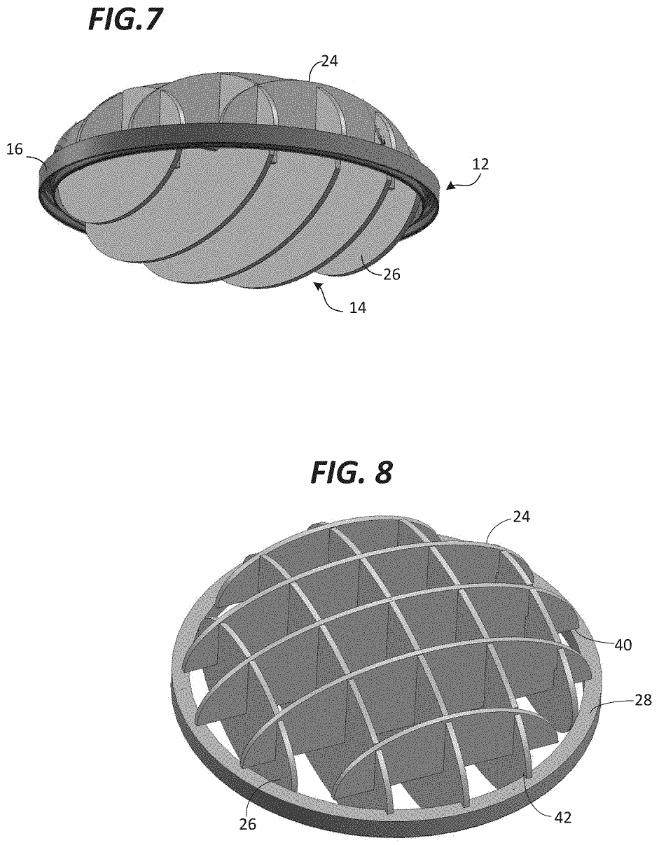

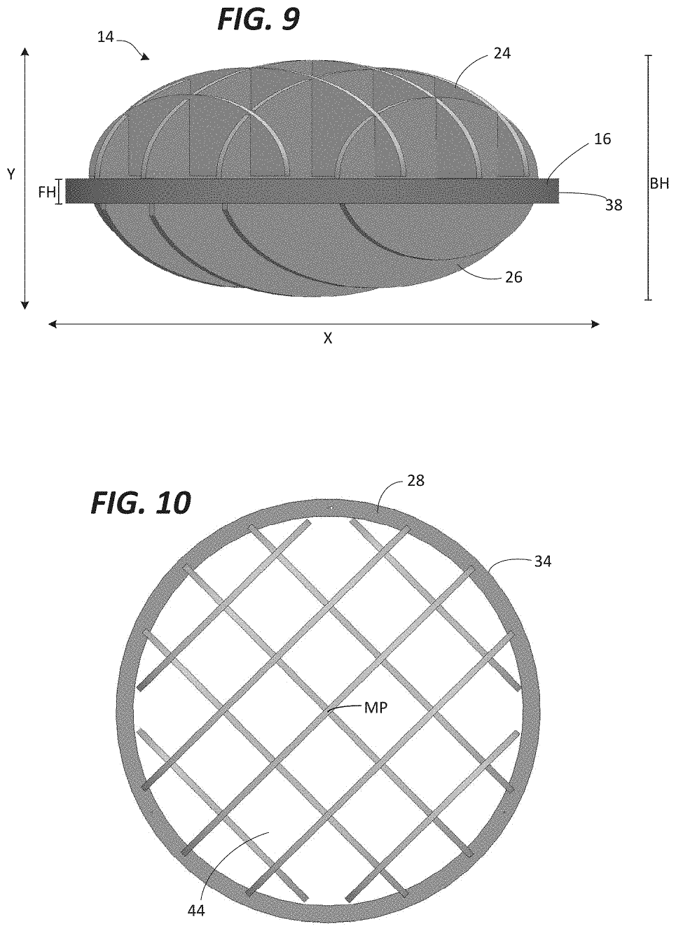

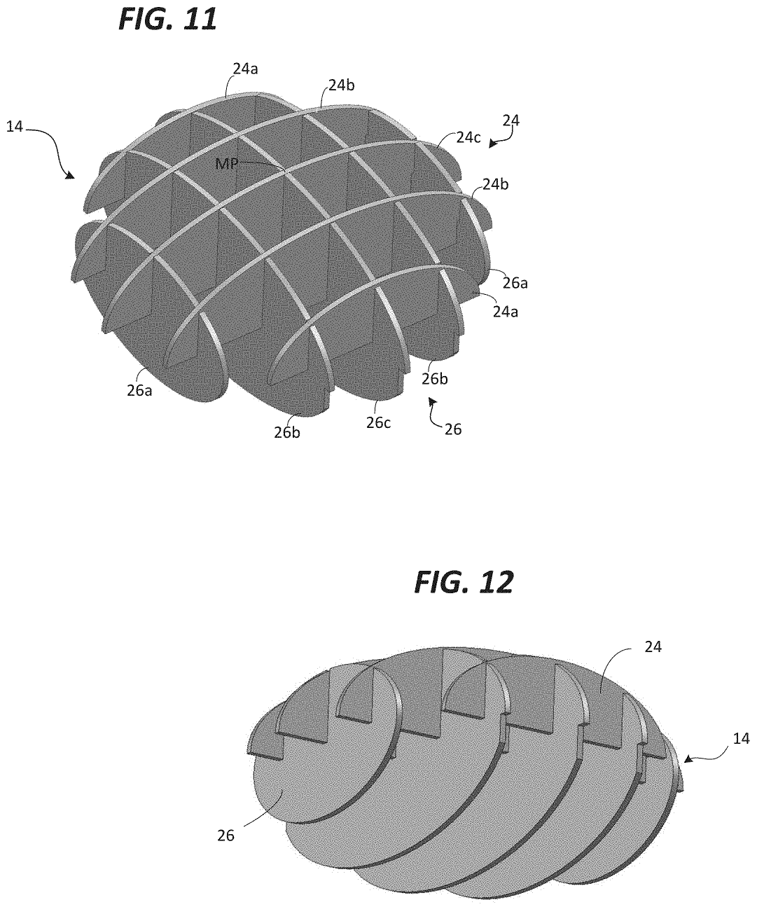

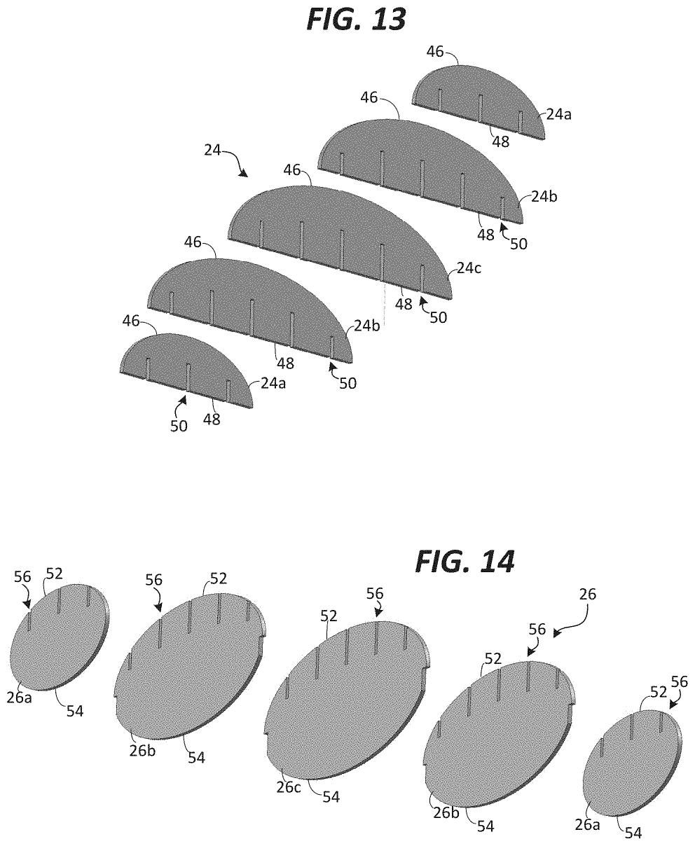

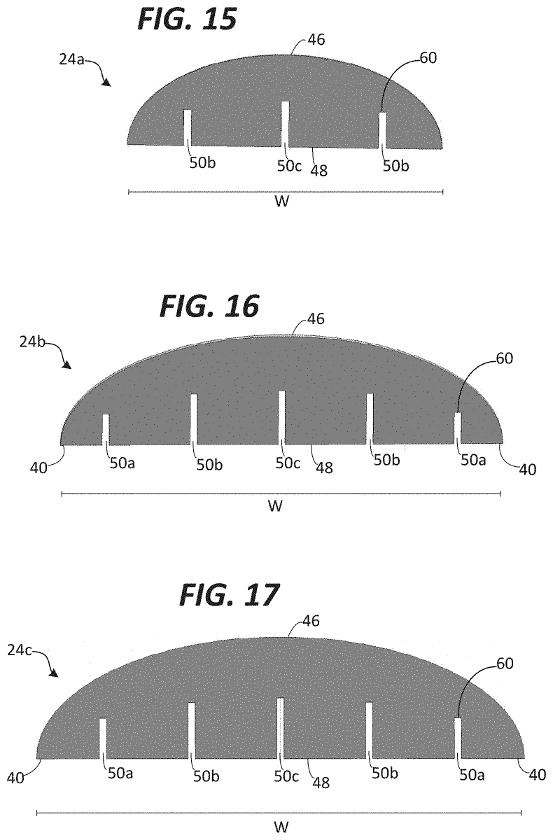

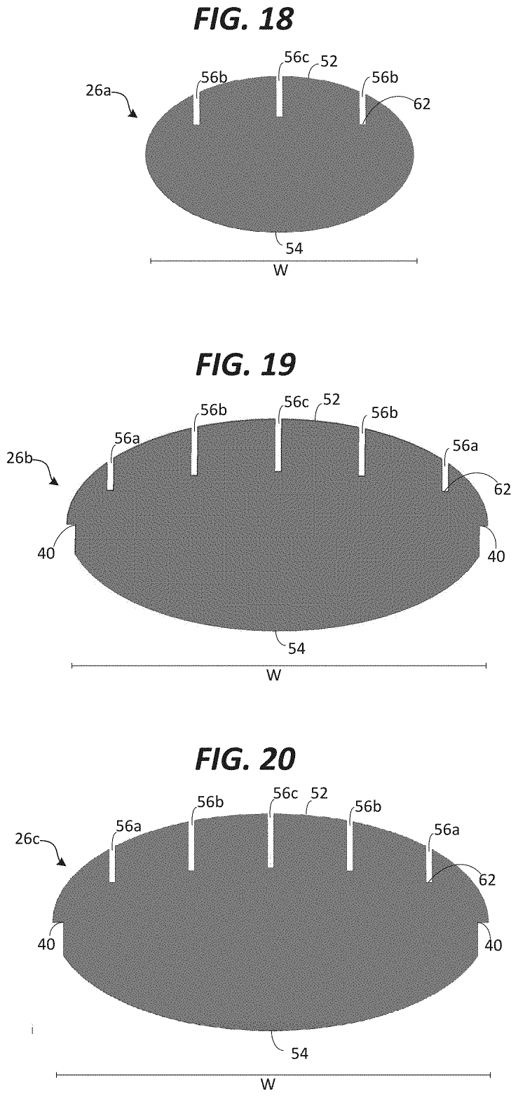

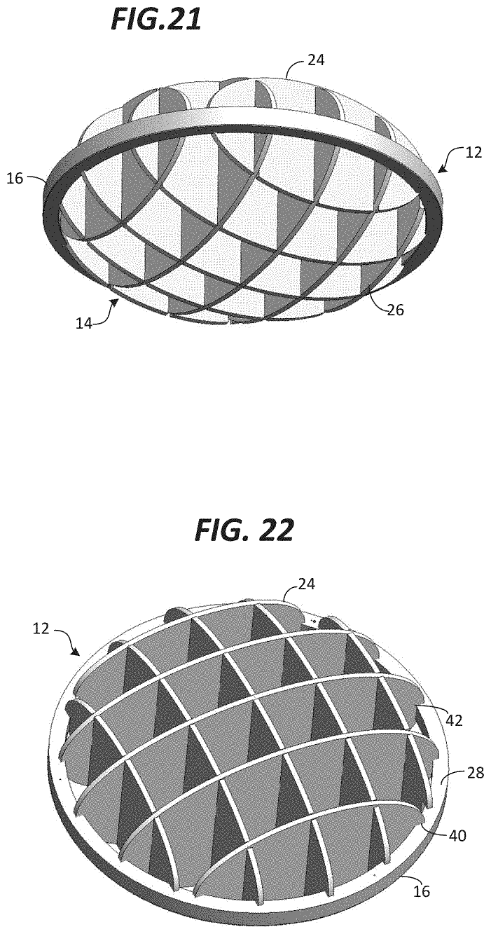

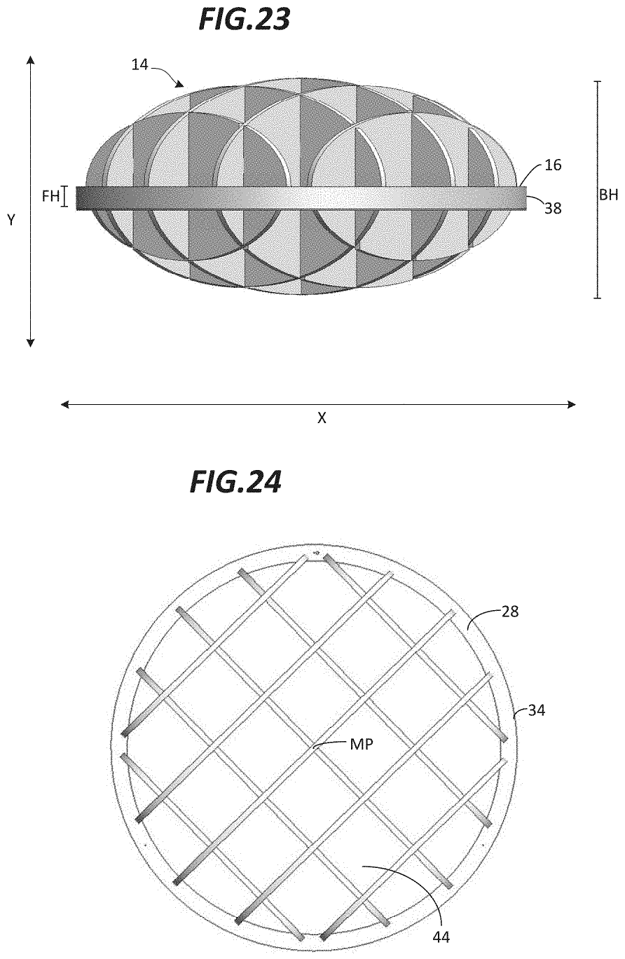

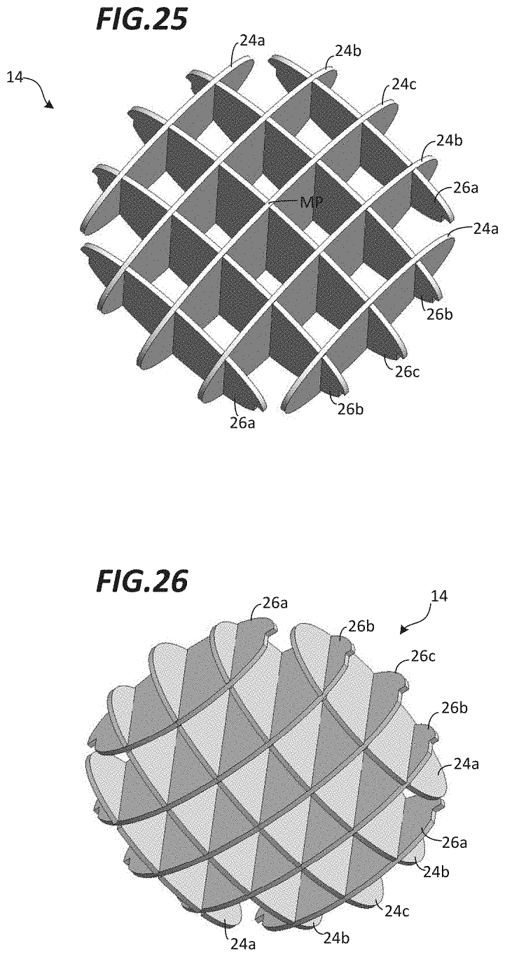

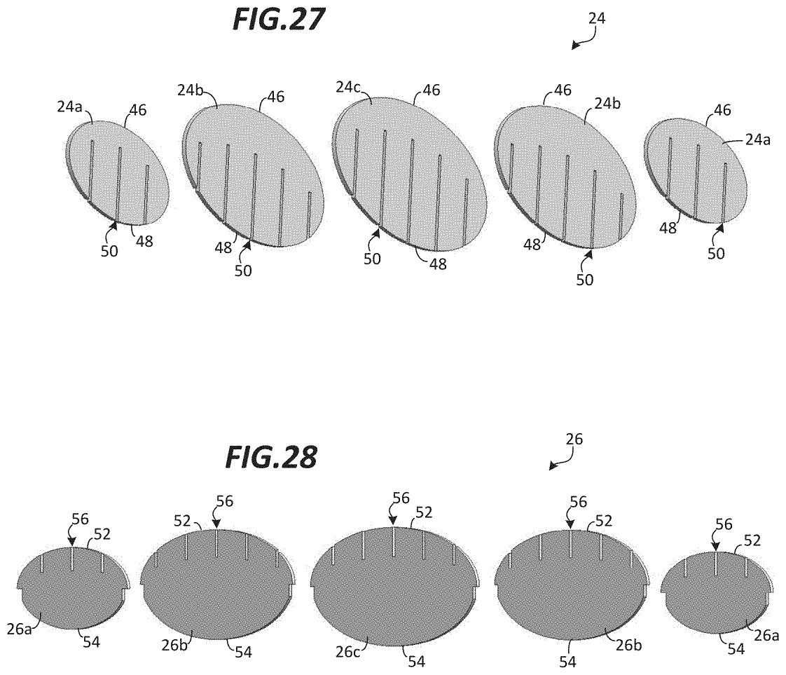

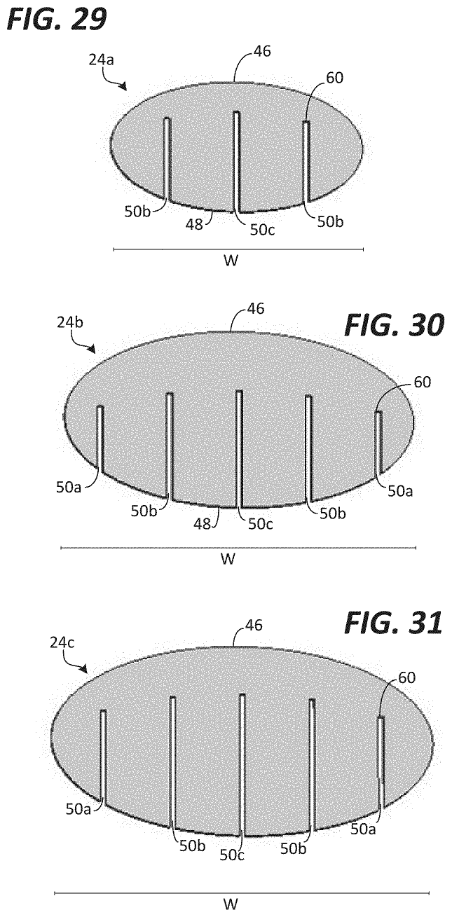

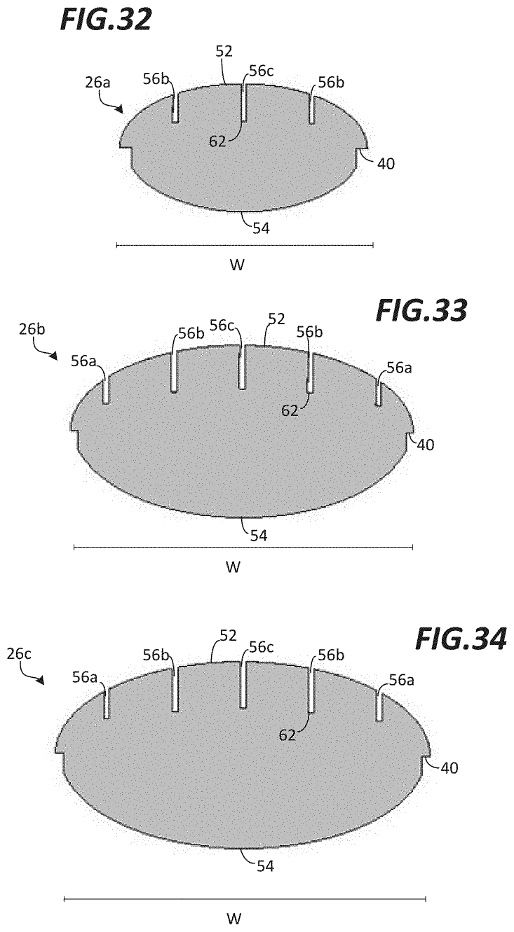

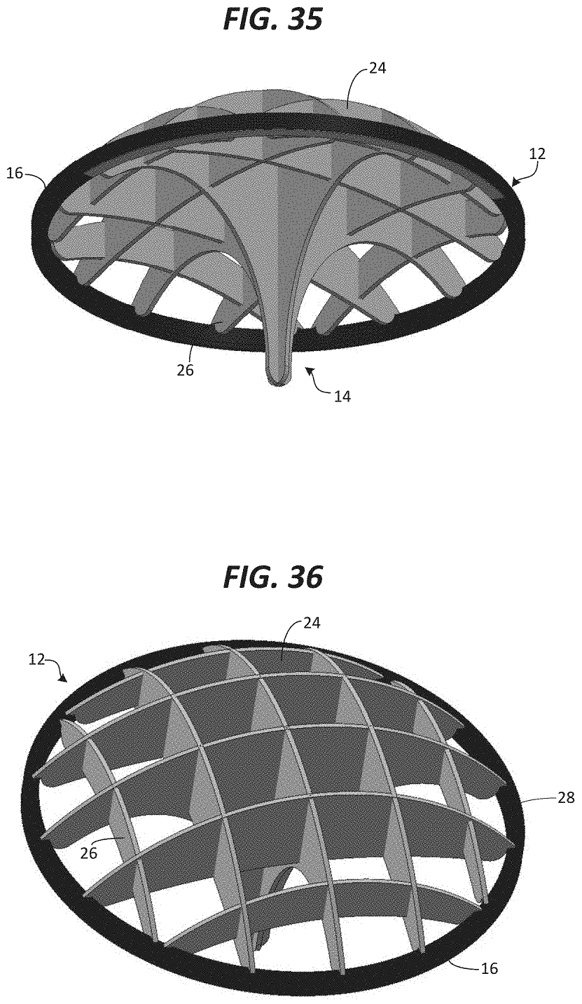

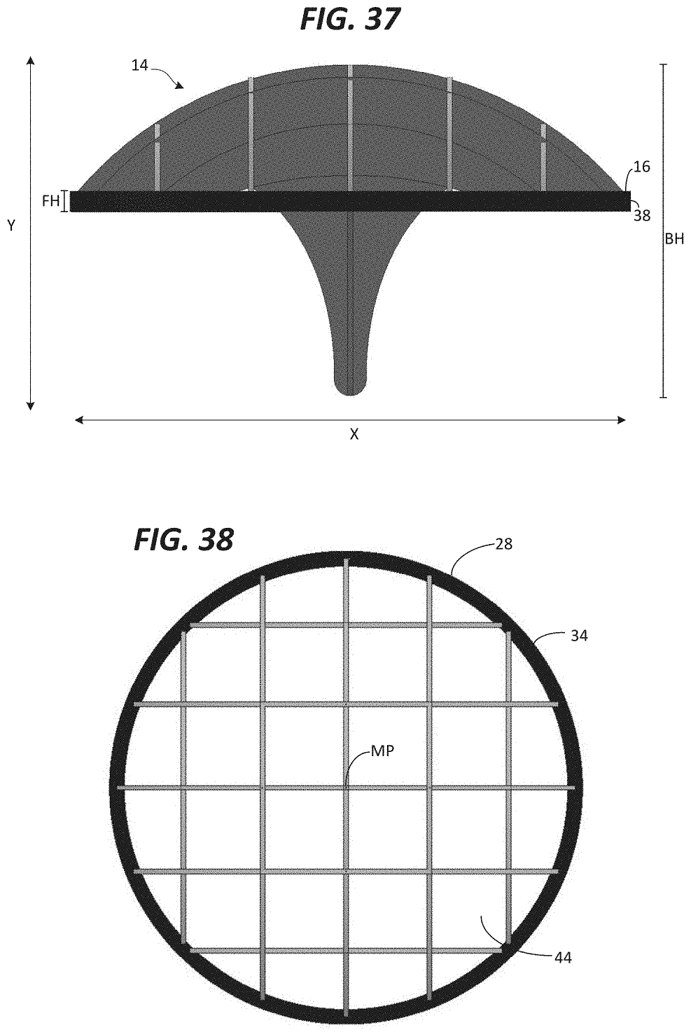

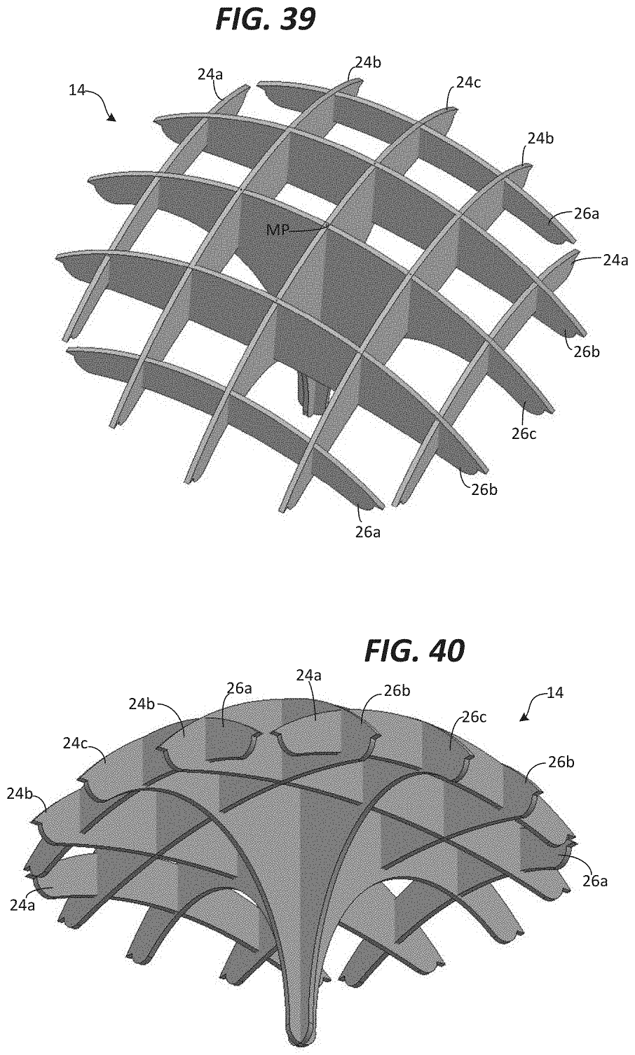

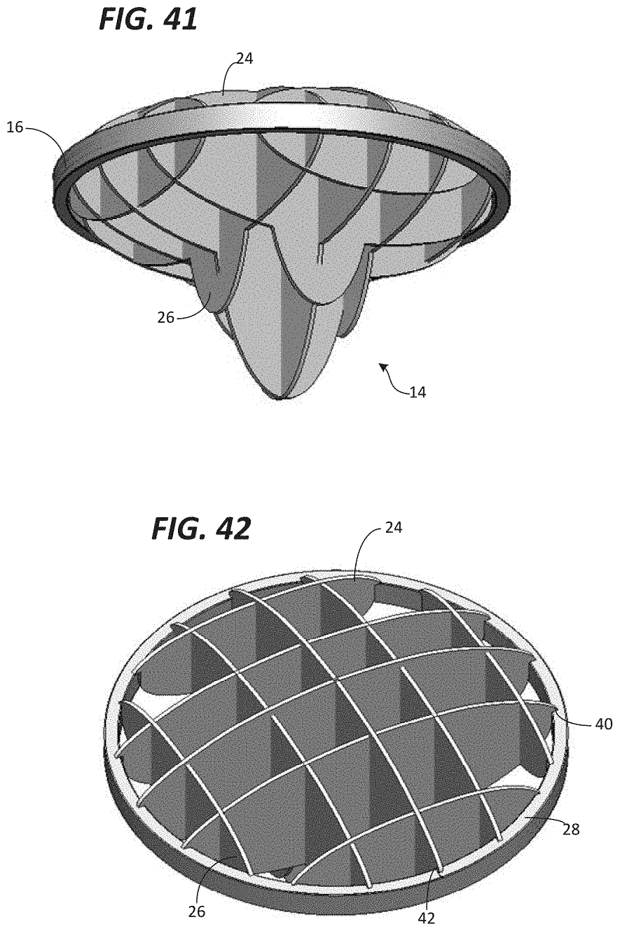

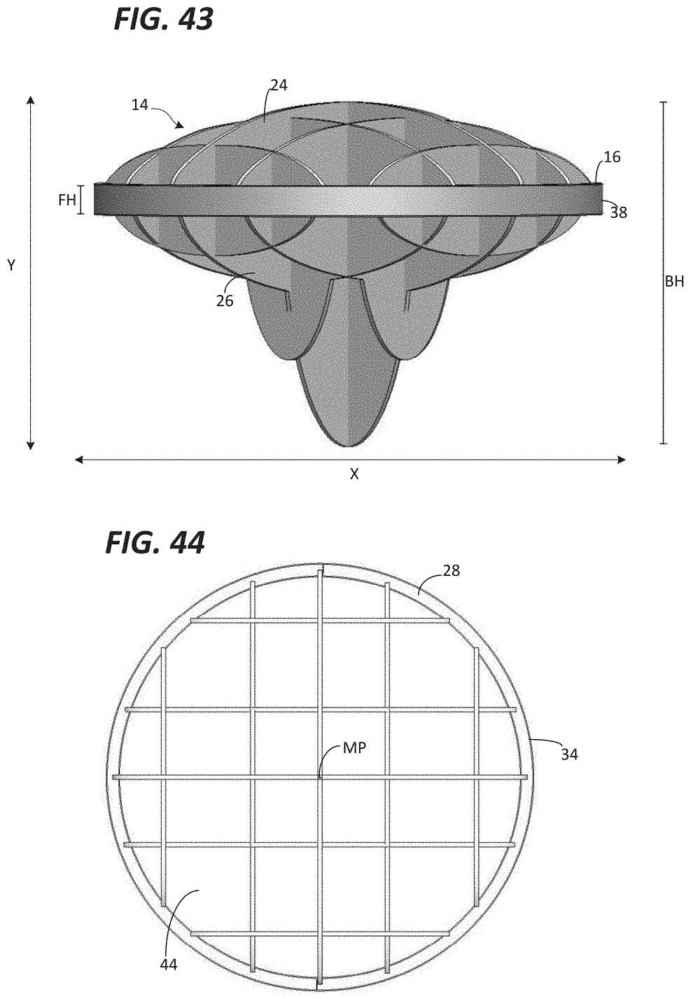

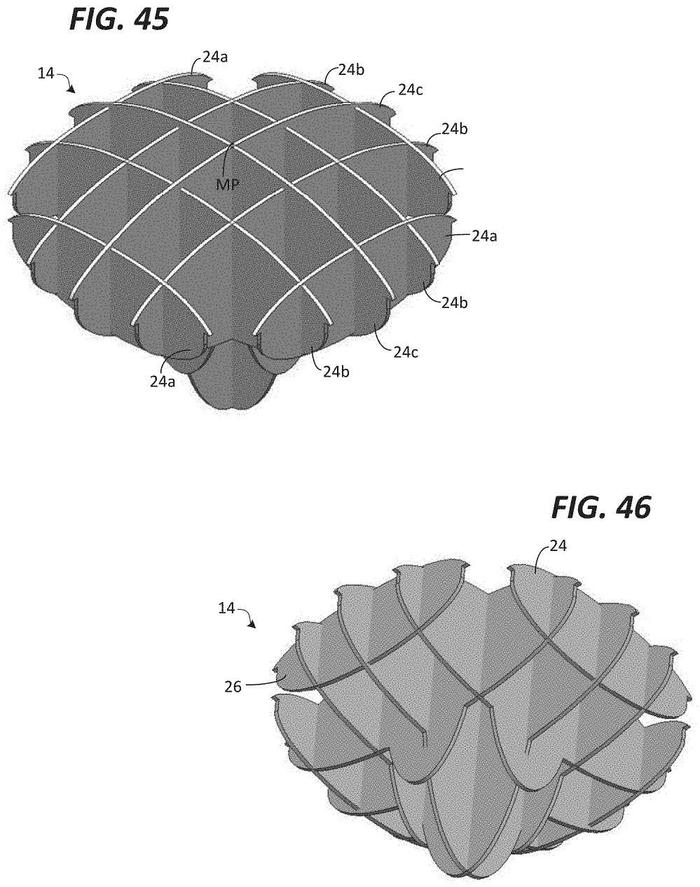

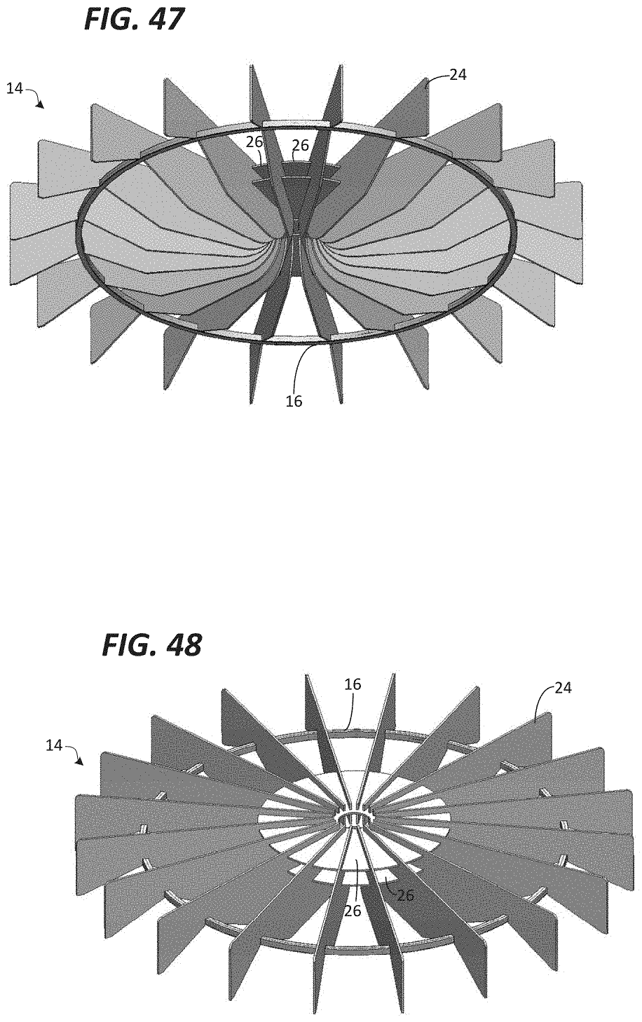

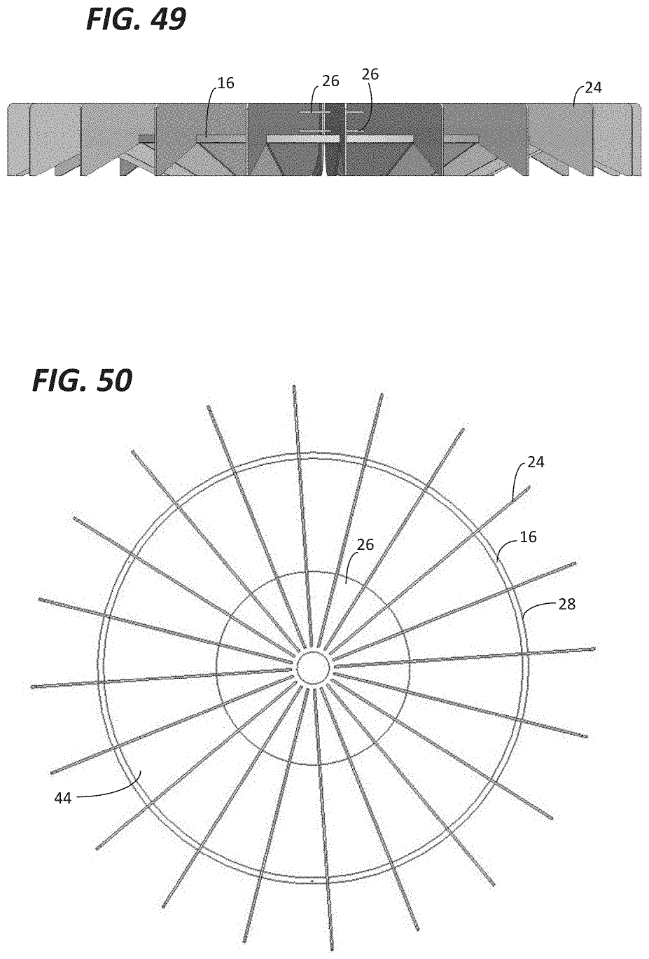

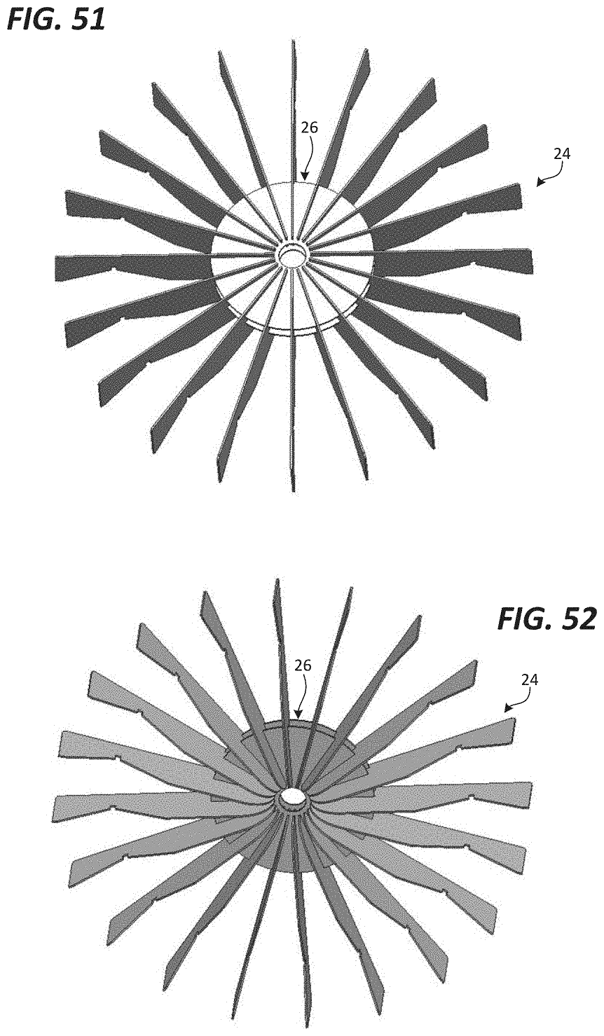

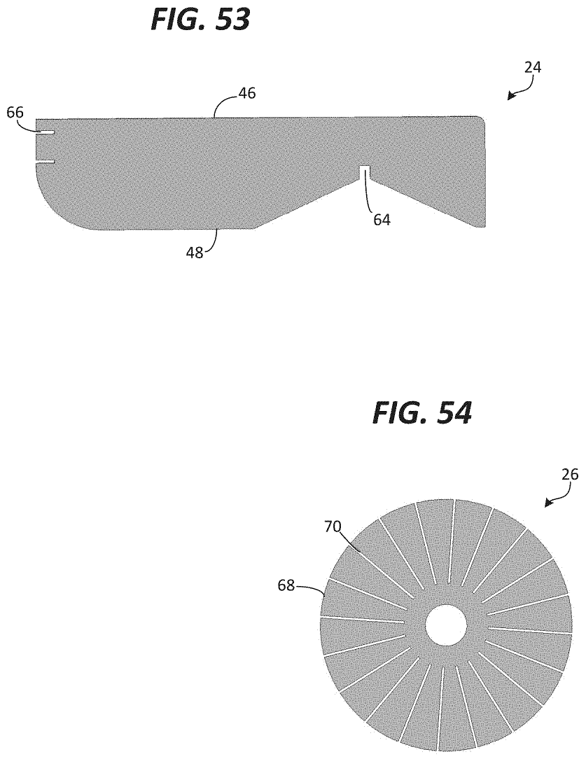

Multiple embodiments of a baffle assembly 14 that can be attached to the frame 16 of the lighting apparatus 12 are disclosed. FIGS. 7-20 illustrate a first embodiment, FIGS. 21-34 illustrate a second embodiment, FIGS. 35-40 illustrate a third embodiment, FIGS. 41-46 illustrate a fourth embodiment and FIGS. 47-54 illustrate a fifth embodiment.

The baffle assembly 14 generally includes a plurality of sound dampening baffles. Each baffle can be provided in the form of a panel or other planar structure that extends in a substantially vertical plane Y or a substantially horizontal plane X. In some cases, the baffle assembly 14 consists essentially of a plurality of sound dampening baffles such that no other structure other than the baffles make up the assembly. In certain cases, the baffle assembly 14 consists essentially of a single material, for example a rigid material such as polyethylene terephthalate.

The plurality of sound dampening baffles includes a plurality of primary baffles 24 and a plurality of secondary baffles 26. In certain embodiments, at least one primary baffle in the plurality of primary baffles 24 is attached to a secondary baffle in the plurality of secondary baffles 26. In some cases, the primary baffles 24 are fixed to the secondary baffles 26 in an interlocking structure. The baffle assembly 14 can be attached to the frame 16 without using adhesives or mechanical tools if desired.

The baffle assembly 14 is housed within a substantially hollow interior 36 of a frame 16. The baffle assembly 14 protrudes upward from the top sidewall 28 and protrudes downward from the bottom sidewall 30. The baffle assembly 14 also has a height BH and the frame 16 has a height FH. The baffle assembly height BH is the total height of the entire baffle assembly 14.

The frame height FH is distance between the top sidewall 28 and bottom sidewall 30 of the frame 16. In some cases, the baffle assembly height BH is greater than the frame height FH. In certain cases, the baffle assembly height BH is more than two times, more than three times, more than four times, more than five times, more than six times, more than 7 times, more than 8 times, more than 9 times or more than 10 times the frame height FH. In specific cases, the frame height FH is in the range of between 1 inch and 3 inches and the baffle assembly height BH is more than two times, more than three times, more than four times, more than five times, more than six times, more than 7 times, more than 8 times, more than 9 times or more than 10 times the frame height FH.

Additionally, in some cases, the baffle assembly 14 protrudes upward from the top sidewall 28 for a distance that is greater than the frame height FH. In certain cases, the baffle assembly 14 protrudes upward from the top sidewall 28 for a distance that is more than two times, more than three times, more than four times, more than five times, more than six times, more than 7 times, more than 8 times, more than 9 times or more than 10 times the frame height FH. Likewise, in some cases, the baffle assembly 14 protrudes downward from the bottom sidewall 30 for a distance that is more than two times, more than three times, more than four times, more than five times, more than six times, more than 7 times, more than 8 times, more than 9 times or more than 10 times the frame height FH.

The above-described configurations help increase the number of baffles that can be provided in the baffle assembly 14, which in turn increases a surface area SA of the baffle assembly 14. The baffle assembly surface area SA is a total exposed surface area of all of the baffles in the baffle assembly 14. When the baffle assembly 14 has an increased surface area SA relative to the frame height FH, sound dampening will be enhanced.

In certain embodiments, the plurality of primary baffles 24 are attached to the plurality of secondary baffles 26 such that the plurality of primary baffles 24 do not extend below a top sidewall 28 of the frame 16. The plurality of secondary baffles 26 however can be provided within the substantially hollow interior 36 such that the baffles 26 extend both upward from the top sidewall 28 and downward from the bottom sidewall 30. Also, in some examples, the baffle assembly 14 protrudes upward from the top sidewall 28 but does not protrude downward from the bottom sidewall 30. In some of such examples, the entire baffle assembly 14 protrudes upward from the top sidewall such that none of it is contained within the frame 16.

In some examples, more of the height BH of the baffle assembly 14 protrudes downward from the bottom sidewall 30 than protrudes upward from the top sidewall 28. For example, in some cases, at least 50%, at least 60%, at least 70%, at least 80% or at least 90% of the BH protrudes downward from the bottom sidewall 30, leaving very little left to protrude upward from the top sidewall 28. In some such examples, the only portion of the height BH of the baffle assembly 14 that protrudes upward from the top sidewall 28 is the portion that rests upon the top sidewall 28 to hold the baffle assembly in place relative to the light apparatus 12.

Also, in some cases, the baffle assembly 14 does not protrude outward past the outer sidewall 34. This allows for the baffle assembly 14 to remain stably supported by the frame 16 while having the above described upward and downward protrusions, which increase the surface area SA of the baffle assembly 14. Further, this allows the baffle assembly 14 to have an enhanced structural integrity and stability when attached to the frame 16.

Also, in some cases, the substantially hollow interior defined by the inner sidewall 32 has an area A and the baffle assembly 14 has a surface area SA that is greater than the cross-sectional area A of the substantially hollow interior 36. In some cases, the surface area SA is more than two times or more than three times or more than four times the cross-sectional area A of the substantially hollow interior 36.

In some cases, the baffle assembly 14 is housed within the substantially hollow interior 36 such that the weight of the baffle assembly 14 is supported by a top sidewall 28 of the frame 16. In some cases, the frame 16 has a frame weight and the baffle assembly 14 has a baffle assembly weight. The frame weight is the entire weight of the frame 16 with a light source 58. Also, the baffle assembly weight is the entire weight of the assembled baffle assembly 14. The baffle assembly weight 14 can be less than 90% (or less than 80%, less the frame weight, less than 80% the frame weight, less than 70% the frame weight, less than 60% the frame weight or less than 50% the frame weight.

Further, certain embodiments of the baffle assembly 14 include an abutment edge 40 that directly abuts the top sidewall 28 of the frame. Also, certain embodiments include an abutment corner 42 that directly abuts both a top sidewall 28 and inner sidewall 32 of the frame 16. Other embodiments include an abutment slot 64 that receives the frame 16.

In some embodiments, at least one baffle includes an abutment edge 40, abutment corner 42 and/or abutment slot 64. In certain cases, at least two (or perhaps at least three) baffles include an abutment edge 40, abutment corner 42 and/or abutment slot 64. In certain cases, all baffles include an abutment edge 40, abutment corner 42 and/or abutment slot 64.

The frame 16 also has a sufficient thickness T that supports an abutment edge 40, abutment corner 42 or abutment slot 64. In some cases, the thickness T is at least 1 inch or perhaps at least 2 inches. In certain cases, the thickness T is in the range of between 1 inch and 3 inches. The frame 16 also has a frame height FH that in combination with the frame thickness T supports an abutment corner 42. In some cases, the frame height FT is in the range of between 1 inch and 3 inches. Such configurations help to fix the baffle assembly 14 to the frame 16 and help stabilize weight of the baffle assembly 14 on the top sidewall 28.

Certain baffles of the assembled baffle assembly 14 extend in a substantially vertical plane Y. This allows the baffles to define a plurality of flow-through spaces 44. Air and water can move generally vertically through the flow-through spaces 44 without contacting any structure extending in a horizontal plane. This allows not only for improved air flow through the baffle assembly 14 but allows for water of a ceiling sprinkler system to easily move downward through the baffle assembly 14 in case of a fire.

The plurality of flow-through spaces 44 also provide a total cross-sectional area that is a combined cross-sectional area of each flow-through space 44 within the horizontal plane of the substantially hollow interior 36. In certain cases, the flow-through spaces 44 provide a total cross-sectional area that is at least 50%, at least 60%, at least 70% or at least 80% of the cross-sectional area A of the substantially hollow interior 36. Such total cross-sectional areas allow for air and water flow through the flow-through spaces 44 to be enhanced.

By providing the baffle assembly 14 within the frame 16 using one or more of the above-described features, sound dampening properties are improved. Additionally, the above-described features allow for a baffle assembly 14 to remain stably fixed to the frame 16 without the use of mechanical tools or adhesives. Skilled artisans will understand that in certain embodiments mechanical tools or adhesives can be used if desired, but they are not necessary.

Each baffle in the plurality of sound dampening baffles comprises or consists essentially of a rigid material. In some cases, the rigid material is a material that can be bent but cannot be folded. For example, the rigid material can include or be polyethylene terephthalate. In specific cases, the rigid material can include or be polyethylene terephthalate felt.

In certain embodiments, the plurality of primary baffles 24 are connected to or engaged with or mated with a plurality of secondary baffles 26 such that the plurality of primary baffles 24 form an interlocking structure with the plurality of secondary baffles 26. In this interlocking structure, the plurality of primary baffles 24 are generally parallel to one another and the plurality of secondary baffles 26 are generally parallel to one another. Additionally, the plurality of primary baffles 24 are generally perpendicular to the plurality of secondary baffles 26. Such a configuration provides a series of flow-through spaces 44. Additionally, this configuration helps provide structural integrity to the baffle assembly 14.

Also, in some embodiments, each primary baffle of the plurality of primary baffles 24 is attached to at least one secondary baffle in the plurality of secondary baffles 26. In some cases, each primary baffle is attached to two or more (or perhaps three or more) secondary baffles. Likewise, each secondary baffle is attached to at least one primary baffle. In some cases, each secondary baffle is attached to two or more (or perhaps three or more) primary baffles. Further, at least one primary baffle is attached to each secondary baffle. In some cases, at least two (or perhaps at least three) primary baffles are attached to each secondary baffle. Similarly, at least one secondary baffle is attached to each primary baffle. In some cases, at least two (or perhaps at least three) secondary baffles are attached to each primary baffle.

Each primary baffle can be attached to a secondary baffle (and each secondary baffle can be attached to a primary baffle) using several different mechanisms. In some embodiments, each primary baffle is slidably engaged with a secondary baffle and each secondary baffle is slidably engaged with a primary baffle.

In certain embodiments, each primary baffle in the plurality of primary baffles 24 includes a top edge 46, a bottom edge 48 and a plurality of bottom slots 50. Each bottom slot 50 can be a slot-like cut or cutout that extends upward from the bottom edge 48 to a closed bottom slot end 60. The distance between the bottom edge 48 to the closed bottom slot end 60 is a bottom slot length. Similarly, each secondary baffle in the plurality of secondary baffles 26 includes a top edge 52, a bottom edge 54 and a plurality of top slots 56. Each top slot 56 can be a slot-like cut or cutout that extends downward from the top edge 52 to a closed top slot end 62. The distance between the top edge 52 to the closed bottom slot end 62 is a top slot length.

A bottom slot 50 of a primary baffle can be slidably engaged with a top slot 56 of a secondary baffle. For example, a bottom slot 50 is slidably engaged with a top slot 56 such that a closed bottom slot end 60 abuts a closed top slot end 62. Also, when the closed bottom slot end 60 abuts the closed top slot end 62, the primary baffle is positioned perpendicular to the secondary baffle.

The plurality of primary baffles 24 can also include outer primary baffles 24a, inner primary baffles 24b and a central primary baffle 24c. The baffle assembly 14 can also have a central midpoint MP. In the illustrated embodiment, the outer primary baffles 24a are further from the central midpoint MP than the inner primary baffles 24b and the central primary baffle 24c. Likewise, the inner primary baffles 24b are further from the central midpoint MP than the central primary baffle 24c. Also, two inner primary baffles 24b and two outer primary baffles 24c are shown. However, skilled artisans will understand that the inner primary baffles 26b can include additional inner primary baffles and outer primary baffles 24c can include additional outer primary baffles.

Similarly, the plurality of secondary baffles 26 include outer secondary baffles 26a, inner secondary baffles 26b and a central secondary baffle 26c. The outer secondary baffles 26a are further from the central midpoint MP than the inner secondary baffles 26b and the central secondary baffle 26c. Also, the inner secondary baffles 26b are further from the central midpoint MP than the central secondary baffle 26c. Also, two inner secondary baffles 26b and two outer secondary baffles 26c are shown. However, skilled artisans will understand that the inner secondary baffles 26b can include additional inner secondary baffles and outer secondary baffles 26c can include additional outer secondary baffles. Additionally, the central primary baffle 24c intersects with the central secondary baffle 26c at the central midpoint MP. This intersection at the central midpoint MP helps provide stability to the baffle assembly 14.

In some cases, an outer primary baffle 26a can include a central bottom slot 50c and outer bottom slots 50a. Also, in some cases, an inner primary baffle 24b can include a central bottom slot 50c, inner bottom slots 50b and outer bottom slots 50a. Each inner bottom slot 50b is provided in between the central bottom slot 50c and an outer bottom slot 50a. Similarly, in some cases, an outer primary baffle 24c can include a central bottom slot 50c, inner bottom slots 50b and outer bottom slots 50a. Here too, each inner bottom slot 50b can be provided in between the central bottom slot 50c and an outer bottom slot 50. In each primary baffle, the central bottom slot 56c can align with an axis of the central midpoint M of the assembled baffle assembly 14.

The central bottom slot 50c has a bottom slot length that is greater than a bottom slot length of each inner bottom slot 50b. Further, each inner bottom slot 50b can have a bottom slot length that is greater than a bottom slot length of each outer bottom slot 50c. The central bottom slot 50c therefore can have a bottom slot length that is greater than a bottom slot length of each inner bottom slot 50b and the outer slot length of each outer bottom slot 50c. The inner bottom slots 50b can also have a substantially same slot length while the outer bottom slots 50a can have a substantially same slot length.

In some cases, an outer secondary baffle 26a can include a central top slot 50c and outer top slots 50a. Also, in some cases, an inner secondary baffle 26b can include a central top slot 56c, inner top slots 56b and outer top slots 56a. Each inner top slot 56b can be provided in between the central top slot 56c and an outer top slot 56a. Similarly, in some cases, an inner secondary baffle 26c can include a central top slot 56c, inner top slots 56b and outer top slots 56a. Each inner top slot 50b can be provided in between the central top slot 56c and an outer top slot 56a. In certain cases, the central top slot 56c can have a top slot length that is greater than a top slot length of each inner top slot 56b. Further, each inner top slot 56b can have a top slot length that is greater than a slot length of each outer top slot 56c. The central top slot 56c therefore can have a top slot length that is greater than a top slot length of each inner top slot 56b and a top slot length of each outer top slot 56c. The inner top slots 56b can also have a substantially same top slot length while the outer top slots 56a can have a substantially same top slot length. In each secondary baffle, the central top slot 56c can align with an axis of the central midpoint M of the assembled baffle assembly 14.

The plurality of primary baffles 24 can also include outer primary baffles 24a having a width, inner primary baffles 24b having a width and a central primary baffles 24c having a width. Each width is a width of the entire baffle panel. The central primary baffle 24c can have a width that is greater than a width of each inner primary baffle 24b. Further, each inner primary baffle 24b can have a width that is greater than a width of each outer primary baffle 24a. The central primary baffle 24c therefore can have a width that is greater than a width of each inner primary baffle 24b and each outer primary baffle 24a. Further, the inner primary baffles 24b can have a substantially same width and the outer primary baffles 24c can have a substantially same width.

Also, the plurality of secondary baffles 26 can also include outer secondary baffles 26a having a width, inner secondary baffles 26b having a width and a central secondary baffles 26c having a width. Each width is a width of the entire baffle panel. The central secondary baffle 26c can have a width that is greater than a width of each inner secondary baffle 26b. Further, each inner secondary baffle 26b can have a width that is greater than a width of each outer secondary baffle 26a. The central secondary baffle 26c therefore can have a width that is greater than a width of each inner secondary baffle 26b and each outer secondary baffle 26a. Further, the inner secondary baffles 26b can have a substantially same width and the outer secondary baffles 26c can have a substantially same width.

1-64. (canceled)

65. A lighting apparatus and baffle assembly combination, comprising:
a lighting apparatus comprising a frame and a light source, wherein the frame extends in a substantially horizontal plane and has a frame height and a frame weight, wherein the frame comprises an outer sidewall, an inner sidewall, a top sidewall and a bottom sidewall, wherein the outer sidewall defines an outer perimeter and the inner sidewall defines a substantially hollow interior and wherein the top sidewall faces a ceiling and the bottom sidewall is opposite the top sidewall;
a baffle assembly comprising a plurality of sound dampening baffles housed within the substantially hollow interior and fixed to the frame and wherein the baffle assembly protrudes downward from the bottom sidewall.

66. The combination of claim 65 wherein the baffle assembly protrudes downward from the bottom sidewall for a distance that is more than two times the frame height.

67. The combination of claim 65 wherein the baffle assembly protrudes upward from the top sidewall for a distance that is more than two times the frame height.

68. The combination of claim 65 wherein the baffle assembly has a baffle assembly height and the baffle assembly height is more than two times the frame height.

69. The combination of claim 65 wherein the substantially hollow interior has an area, and wherein the baffle assembly has a total exposed surface of the plurality of sound dampening baffles, wherein the total exposed surface has a surface area that is greater than the area of the substantially hollow interior.

70. The combination of claim 69 wherein the total exposed surface has a surface area that more than two times the area of the substantially hollow interior.

71. The combination of claim 65 wherein each baffle in the plurality of sound dampening baffles extends in a substantially vertical plane such that the plurality of sound dampening baffles define a plurality of flow-through spaces, wherein some air or water can move vertically through the flow-through spaces without contacting any structure extending in a horizontal plane.

72. The combination of claim 65 wherein the baffle assembly consists essentially of a plurality of sound dampening baffles that are attached to the frame without being adhesively or mechanically fixed to the frame or any other component.

73. The combination of claim 65 wherein the baffle assembly has a baffle assembly weight that is less than 90% the frame weight.

74. A lighting apparatus and baffle assembly combination, comprising:
a lighting apparatus comprising a frame and a light source;
wherein the frame extends in a substantially horizontal plane and has a frame height and a frame weight;
a baffle assembly consisting essentially of a plurality of sound dampening baffles, wherein the plurality of sound dampening baffles consists essentially of a single material;
wherein the baffle assembly is attached to the frame without being adhesively or mechanically fixed to the frame or any other component.

75. The combination of claim 74 wherein the single material comprises a rigid material.

76. The combination of claim 74 wherein the baffle assembly has a baffle assembly weight, wherein the baffle assembly weight is less than 90% the frame weight.

77. The combination of claim 74 wherein the frame comprises an outer sidewall, an inner sidewall, a top sidewall and a bottom sidewall, wherein the outer sidewall defines an outer perimeter, the inner sidewall defines a substantially hollow interior, the top sidewall faces a ceiling and the bottom sidewall is opposite the top sidewall, wherein the baffle assembly protrudes downward from the bottom sidewall.

78. The combination of claim 77 wherein the baffle assembly protrudes downward from the bottom sidewall for a distance that is more than two times the frame height.

79. The combination of claim 77 wherein the baffle assembly protrudes upward from the top sidewall for a distance that is more than two times the frame height.

80. The combination of claim 74 wherein baffle assembly has a baffle assembly height that is more than two times the frame height.

81. The combination of claim 74 wherein each baffle in the plurality of sound dampening baffles extends in a substantially vertical plane such that the plurality of sound dampening baffles define a plurality of flow-through spaces, wherein some air or water can move vertically through the flow-through spaces without contacting any structure extending in a horizontal plane.

82. A lighting apparatus and baffle assembly combination, comprising:
a lighting apparatus comprising a frame and a light source, wherein the frame extends in a substantially horizontal plane; and
a baffle assembly comprising a plurality of sound dampening baffles, wherein the plurality of sound dampening baffles includes a plurality of primary baffles extending in a substantially vertical plane, and a plurality of secondary baffles extending in a substantially vertical plane, wherein the plurality of primary baffles are perpendicular to the plurality of secondary baffles.

83. The combination of claim 82 wherein at least one primary baffle is attached to each secondary baffle and at least one secondary baffle is attached to each primary baffle.

84. The combination of claim 83 wherein each primary baffle is attached to each secondary baffle and each secondary baffle is attached to each primary baffle.

85. The combination of claim 82 wherein at least one primary baffle is slidably engaged with each secondary baffle and at least one secondary baffle is slidably engaged with each primary.

86. The combination of claim 85 wherein each primary baffle is slidably engaged with each secondary baffle and wherein secondary baffle is slidably engaged with each primary baffle.

87. The combination of claim 82 wherein each primary baffle includes a top edge, a bottom edge and a plurality of bottom slots extending upward from the bottom edge, and wherein each secondary baffle includes a top edge, a bottom edge, and a plurality of top slots extending downward from the top edge.

88. The combination of claim 87 wherein at least one bottom slot is slidably engaged with at least one top slot.

89. The combination of claim 87 wherein at least one bottom slot has a closed bottom slot end and at least one top slot has a closed top slot end, wherein the closed bottom slot end abuts the closed top slot end.

90. The combination of claim 82 wherein the plurality of primary baffles includes a central primary baffle and the plurality of secondary baffles includes a central secondary baffle, wherein the central primary baffle intersects with the central secondary baffle at a central midpoint.

91. The combination of claim 90 wherein the plurality of primary baffles further includes additional primary baffles positioned further from a central midpoint than the central primary baffle, and wherein the plurality of secondary baffles further includes additional secondary baffles positioned further from a central midpoint than the central secondary baffle.

92. The combination of claim 91 wherein the central primary baffle has a width that is greater than a width of the additional primary baffles, and wherein the central secondary baffle has a width that is greater than a width of the additional secondary baffles.
